(19) United States
(12) Patent Application Publication
(10) Pub. No.: US 2024/0249147 A1
(43) Pub. Date: Jul. 25, 2024

(54) SYSTEMS AND METHODS FOR POSITIVE UNLABELED LEARNING USING AN ADAPTIVE ASYMMETRIC LOSS FUNCTION

(71) Applicants: Arizona Board of Regents on Behalf of Arizona State University, Tempe, AZ (US); PRIME SOLUTIONS GROUP, INC., Goodyear, AZ (US)

(72) Inventors: Kristen Jaskie, Scottsdale, AZ (US); Nolan Vaughn, Tempe, AZ (US); Vivek Sivaraman Narayanaswamy, Tempe, AZ (US); Sahba Zaare, Mesa, AZ (US); Joseph Marvin, Waddell, AZ (US); Andreas Spanias, Tempe, AZ (US)

(21) Appl. No.: 18/419,340

(22) Filed: Jan. 22, 2024

Related U.S. Application Data
(60) Provisional application No. 63/480,812, filed on Jan. 20, 2023.

(51) Int. Cl. G06N 3/0895

(52) U.S. Cl. CPC G06N 3/0895

(57) ABSTRACT

A system for Positive and Unlabeled (PU) learning is tailored specifically for a deep learning framework. The system incorporates an adaptive asymmetric loss function based on Modified Logistic Regression paired with a simple linear transform of an output. When only positive and unlabeled images are available for training, the system results in an inductive classifier where no estimate of the class prior is required.

### CROSS REFERENCE TO RELATED APPLICATIONS

This is a non-provisional application that claims benefit to U.S. Provisional Application Ser. No. 63/480,812, filed on Jan. 20, 2023, which is herein incorporated by reference in its entirety.

### FIELD

The present disclosure generally relates to deep neural networks, and in particular, to a system and associated method for positive unlabeled learning on deep neural networks using an adaptive asymmetric loss function.

### BACKGROUND

Positive Unlabeled (PU) learning is a type of learning process for deep neural networks that can be used for tasks such as image classification. Unlike traditional semi-supervised learning (SSL), PU learning requires only some labeled data from a positive class. All other data, both positive and negative, is unlabeled. The goals of PU learning can be similar to those of SSL, e.g., to construct a classification model that correctly labels unlabeled images and create a model to label future images. This problem is surprisingly common in the real-world with both commercial and military applications. Detecting a new class in remote sensing is one such example.

It is with these observations in mind, among others, that various aspects of the present disclosure were conceived and developed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1D are a series of graphical representations showing how an adaptive asymmetric loss function of a system outlined herein varies with different parameter values;

FIG. 2A is a simplified diagram showing a training process of a system for classification using Positive Unlabeled learning disclosed herein;

FIG. 2B is a simplified diagram showing an inference process of the system of FIG. 2A; and

FIG. 3 is a simplified diagram showing an example computing device for implementation of the system of FIGS. 2A and 2B.

Corresponding reference characters indicate corresponding elements among the view of the drawings. The headings used in the figures do not limit the scope of the claims.

### DETAILED DESCRIPTION

### 1. Introduction

The present disclosure provides a system and associated methods for Positive Unlabeled (PU) learning through an adaptive asymmetric loss function, and is tailored specifically for a deep learning framework. The present disclosure demonstrates the merit of the system using image classification. When only positive and unlabeled images are available for training, the adaptive asymmetric loss function, paired with a simple linear transform of an output, results in an inductive classifier where no estimate of the class prior is required. This system, sometimes referred to herein as “aaPU” (Adaptive Asymmetric Positive Unlabeled), provides near supervised classification accuracy with very low levels of labeled data on several image benchmark sets. The system demonstrates significant performance improvements over current state-of-the-art positive learning algorithms.

The present disclosure will use what has become a standard notation in this field. A datapoint, in this case an image, will be denoted x̅ and y={0,1} will be its true binary label with y=1 indicating the image belongs to the positive class and y=0, the negative. As many images will be unlabeled in a PU learning problem, let s={0,1} denote the label status of each image, meaning that if s=1 the image is labeled, and if s=0 the image is unlabeled, though its hidden y value could be 0 or 1. By definition, if s=1 then y=1 as only positive data are labeled. Therefore, the p(s=1|y=1) is unknown, but:

$$\\ \begin{matrix}p ( s = 1 \vert y = 0 ) = 0 & ( 1 )\end{matrix}$$

The present novel concept of the subject disclosure builds on a Modified Logistic Regression (MLR) algorithm as described in Jaskie et al. (K. Jaskie, C. Elkan, and A. Spanias, “A Modified Logistic Regression for Positive and Unlabeled Learning,” in IEEE Asilomar, Pacific Grove, California, pp. 0-5, November 2019), herein incorporated by reference in its entirety.

Here, MLR is extended into the deep learning (DL) domain to create a system disclosed herein, also referred to as “aaPU”. The present disclosure demonstrates how, with a custom loss function, near supervised classification accuracy can be obtained on complex images with only a few labeled data from the positive class, as little as 1% or less. This is demonstrated herein on benchmark image datasets including MNIST, Cats-vs-Dogs, and STL-10. In this work, the “Selected Completely At Random” (SCAR) assumption is made, but known class priors are not assumed.

The system is compared against three common algorithms in the field including a “naïve” supervised CNN that treats unlabeled samples as negative, a well-known PU algorithm called nnPU, and an asymmetric loss algorithm from another work that employs a fixed asymmetric loss function instead of an adaptive asymmetric loss function. This is described in detail in section 4.

The rest of this disclosure is organized as follows. Section 2 provides an overview of the PU literature with a focus on image processing and the MLR algorithm. Section 3 describes the configuration and methods applied by the present system. Sections 4 and 5 present the experimental setup and results respectively. Section 6 provides a general computing device that can be used to implement the system disclosed herein.

### 2. Related Work

PU learning algorithms were originally developed for text applications before becoming generalized in the late 2000s. While some limited image classification was possible with non-deep learning techniques, PU image classification effectively began once deep learning methods became possible. This section describes some of the recent and highly referenced work used to solve this same problem and previous efforts on the MLR algorithm.

### 2.1 PU Algorithms for Image Classification

The methods used for PU image classification have varied greatly over the years. Some attempt to augment the labeled set, using either discriminative or generative techniques. Two works attempted to identify probable negative images from the unlabeled set before applying mostly traditional ML classifiers: one used random forests, naïve Bayes, and decision trees while the other focused on support vector machines (SVMs), naïve Bayes, linear models, and a classifier. Some DL work in PU learning used generative adversarial networks (GANs) to generate labeled synthetic samples from a negative distribution or from both negative and positive distributions.

Other work used neural networks (NN) with modified loss functions. In 2015, one work introduced the convex double hinge loss for PU learning. In 2017, another effort extended this work, using a sigmoid loss with a non-negative risk estimator which forced a positive loss value. This algorithm, nnPU, was designed to minimize overfitting, particularly in large-scale datasets. More recently in 2022, one work proposed an asymmetric loss function and deep neural network architecture, outperforming several others. The present disclosure will refer to this algorithm as “aPU” for simplicity when discussing results in Section 4 as no name was given. Generative and self-supervised learning approaches also show some progress.

In contrast with other asymmetric loss functions (such as the one employed in aPU), an asymmetric loss function of the present system is not fixed, but rather adaptive, learned, and based on the structure of the data itself. In addition, the asymmetric loss function of the present system is designed to learn the non-traditional classifier p(s=1|x̅) rather than the more common traditional classifier p(y=1|x̅). A simple linear transform can be applied to convert the non-traditional classifier of the present system to a traditional one.

### 2.2 The MLR Algorithm

The MLR algorithm is a type of non-traditional classifier where: if the labeled positive images are selected completely “at random” (the SCAR assumption) from the set of all positive images, then the label s is independent of the image features x and p(s=1|x̅, y=1)=p(s=1|y=1)=c where c is the constant probability that a positive image is labeled, also called the label frequency. In this case, one goal of the present system can be to calculate the probability that an image is labeled, and dividing it by c as shown in equation 2.

$$\\ \begin{matrix}p ( y = 1 \vert \overline{x} ) = \frac{p ( s = 1 \vert \overline{x} )}{c} & ( 2 )\end{matrix}$$

Particulars of the MLR algorithm are discussed in “K. Jaskie, C. Elkan, and A. Spanias, “A Modified Logistic Regression for Positive and Unlabeled Learning,” in IEEE Asilomar, Pacific Grove, California, pp. 0-5, November 2019”, which is herein incorporated by reference in its entirety.

Previous efforts demonstrated that using a classifier with an adaptive upper bound to calculate the probability that a datapoint, or image in this case, is labeled performs better than traditional classifiers. One implementation of a MLR non-traditional classifier can be described as follows:

$$\\ \begin{matrix}p ( s = 1 \vert \overline{x} ) = \frac{1}{1 + {b}^{{}_{} 2} + {e}^{- {( \overline{w} \cdot \overline{x} )}^{.}}} & ( 3 )\end{matrix}$$

Here, b is a learned parameter like the weight vector w̅. The parameter array could be considered θ=[b, w̅]. After training, the label frequency c can be estimated as:

$$\\ \begin{matrix}\hat{c} = \frac{1}{1 + {b}^{{}_{} 2}} & ( 4 )\end{matrix}$$

Notice that while equation (3) is a sigmoid, it has an adjustable upper bound and asymptote at c, shown in equation (4), which is always between 0 and 1. With p(s=1|x̅) and ĉ, equation (2) can be used to obtain estimates of the probability that a datapoint was positive. Unlike many PU learning algorithms, the class prior p(y=1) is not required to be known or estimated in advance.

The MLR classifier performed extremely well on small classification problems including MNIST. In this disclosure, this classifier is extended into the deep learning domain for PU classification on much larger images and datasets.

### 3. Present System

### 3.1 Adaptive Asymmetric Loss Function

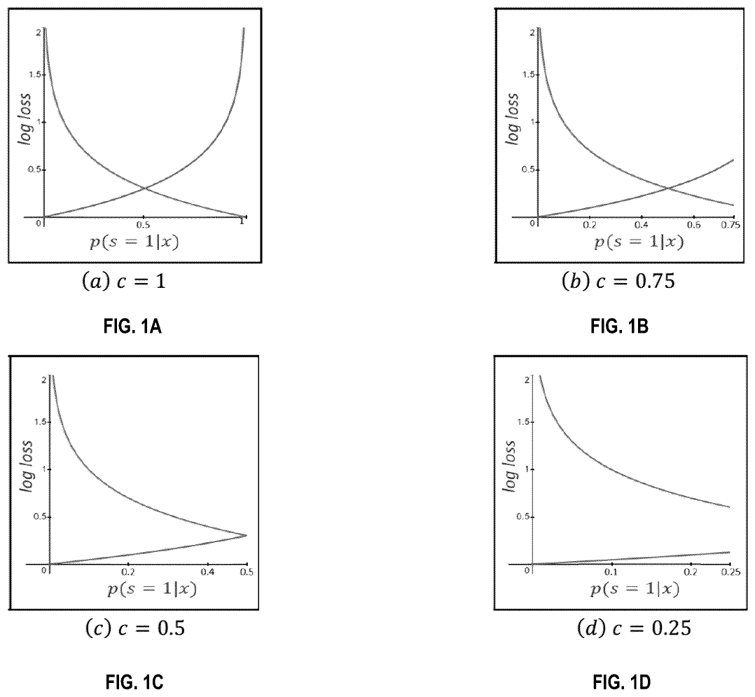

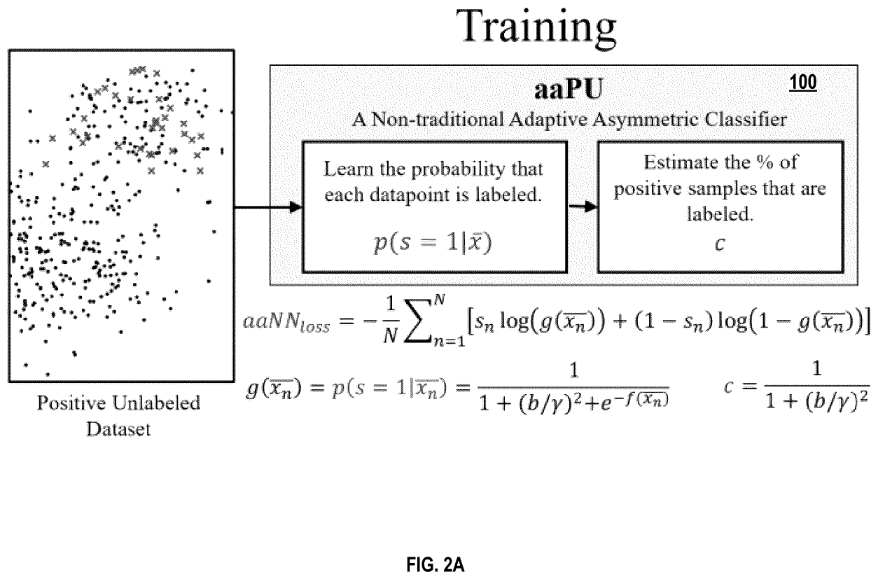

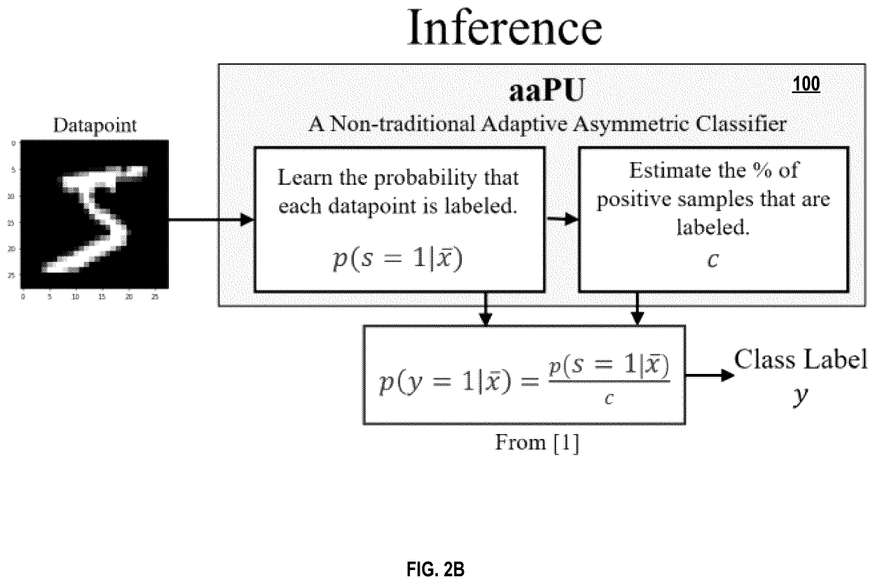

The present disclosure provides a system 100 (FIGS. 2A and 2B) that employs an adaptive asymmetric loss function for PU image classification. A level of asymmetry of the adaptive asymmetric loss function depends on a learned label frequency c, the effects of which are illustrated in the graphical representations of FIGS. 1A-1D. The decreasing function in FIGS. 1A-1D is the log loss when the true label is positive, and the increasing function is the log loss when the true label is negative. When all positive images are labeled (c=1), the loss is equivalent to the standard symmetric binary cross entropy loss. When c<1, the loss becomes asymmetrical. The value of c is learned during training (via the learned parameter b) and so the level of asymmetry is adaptive rather than fixed. This differs from other works where the asymmetrical loss function is a fixed hyperparameter.

The adaptive asymmetric loss function is as follows:

$$\\ \begin{matrix}{aaNN}_{loss} = - \frac{1}{N} [ {\sum }_{n = 1}^{N} {s}_{n} log ( g ( {\overline{x}}_{n} ) ) + ( 1 - {s}_{n} ) log ( g ( {\overline{x}}_{n} ) ) ] & ( 5 )\end{matrix}$$

where N is the size of the dataset and g(x̅ₙ) is the MLR non-traditional classifier adapted for deep learning:

$$\\ \begin{matrix}g ( {\overline{x}}_{n} ) = p ( {s}_{n} = 1 \vert {\overline{x}}_{n} ) = \frac{1}{1 + {( b / γ )}^{2} + {e}^{- f ( {\overline{x}}_{n} )}} & ( 6 )\end{matrix}$$

where equation (3) has been adapted with a regularization term γ to control the smoothness of the gradient and notation has been changed to reflect that the system 100 exponentiates the output of a deep neural net f(x̅ₙ). The p(s=1|y=1)=c is now estimated as follows (and shown in FIGS. 2A and 2B, which respectively show training and inference processes of the system 100 employing the adaptive asymmetric loss function):

$$\\ \begin{matrix}\hat{c} = \frac{1}{1 + {( b / γ )}^{2}} & ( 7 )\end{matrix}$$

Equation (5) is the same as that of standard binary cross entropy, but by using g(x̅₂) as shown in (6), the total loss is allowed to become asymmetric as g(x̅ₙ)≤c≤1. FIGS. 1A-1D illustrate the effects of the adaptive asymmetric loss function of the system 100 for positive and negative data for four different values of c. As c is the upper asymptote for g(x̅), no output will be greater than c.

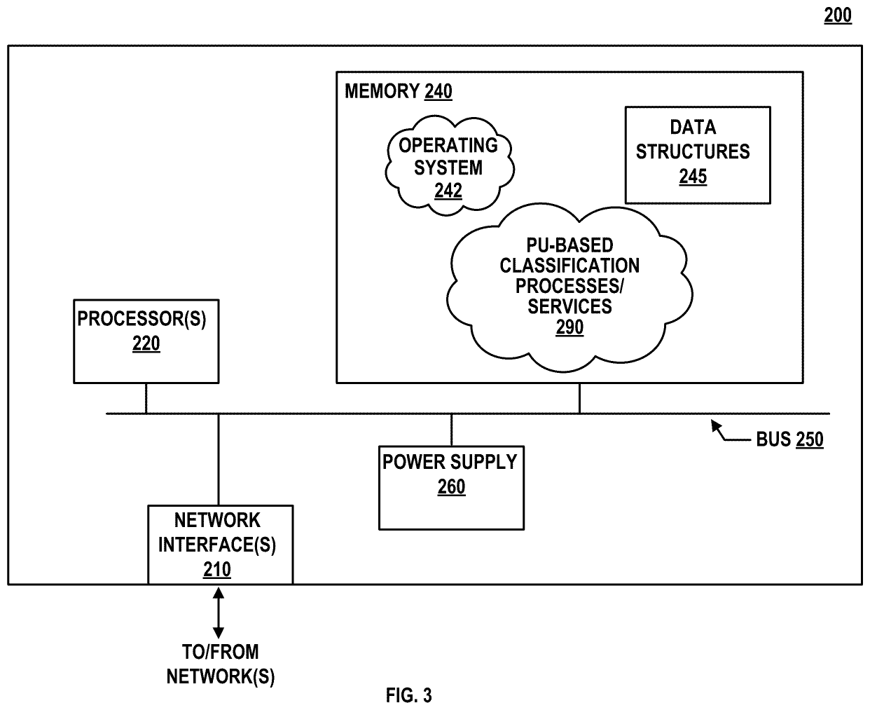

FIGS. 2A and 2B respectively show training and inference processes of the system 100. In the training phase shown in FIG. 2A, a computing device (e.g., device 200 of FIG. 3) trains the system 100 by using a PU (positive unlabeled) dataset such that the system 100 “learns” a probability that a sample x̅ is labeled (s=1) and estimate the percentage c of positive samples that are labeled c=p(s=1|y=1); the adaptive asymmetric loss function incorporates the probability expressed by g(x̅ₙ) as g(x̅ₙ)=p(sₙ=1|x̅ₙ). Equations 5, 6, and 7 are used in the training phase of FIG. 2A. In the inference phase shown in FIG. 2B, at a computing device (e.g., device 200 of FIG. 3) with the system 100 having been trained and formulated at a processor of the computing device, the system 100 uses Equation 2 along with parameters and the c value learned in the training phase of FIG. 2A to estimate a class label y of a new datapoint.

### 3.2 Activation Function Formulation

This adaptive asymmetric loss function of the system 100 can be mathematically considered as using a traditional NN with the output neuron having g(x) as an activation function (shown in equation 6) rather than a standard sigmoid function. The value c can then be calculated (equation 4) and the transform (equation 2) performed to identify the final probabilities.

### 4. Experimental Setup

To test the effectiveness of the system 100, three datasets (with varying levels of positive data labeled) were investigated, and performance results were compared against three state-of-the-art algorithms.

### 4.1 Datasets and Architectures

Three image datasets were selected: the common simple MNIST with small images (28×28×1), the larger Cats-vs-Dogs dataset with large images (224×224×3), and the SSL dataset STL-10 with additional complexity (open training set with 96×96×3 images).

These datasets were selected for the following reasons: the PU learning literature frequently evaluates MNIST as a benchmark and some more recent algorithms have evaluated STL-10. Cats-vs-Dogs was selected as having larger images than were typically found in the literature.

### 4.2 Algorithms

The system 100 was compared against three other common algorithms in the field: a “naïve” supervised CNN (NaivePU) that treats unlabeled samples as negative using standard binary cross-entropy, an nnPU algorithm, and the aPU asymmetric loss algorithm discussed earlier that uses a fixed asymmetric loss function instead of an adaptive asymmetric loss function.

Two different feature extraction back-ends were used. For the MNIST dataset with small images, a simple 3-layer CNN with 3 convolution blocks and an inference head including 2 fully connected layers consisting of 128 and 64 neurons was implemented. For the larger, more complex datasets, an EfficientNetB0 architecture pretrained on ImageNet was used. An inference head of the EfficientNetB0 architecture was removed and replaced with three dense layers of 512, 128, and 64 neurons.

### 4.3 Hyperparameter Tuning

For each dataset, hyperparameter tuning was performed on the system 100 (results shown in Table 1). When available, published results were used for other algorithms and when not available, such as with the Cats-vs-Dogs dataset, the algorithms were tuned and ran specially for the purpose of comparison with the present system, with γ=1 to directly compare to previous efforts.

All trainable variables were randomly initialized except for the b variable in the system 100. Due to the shape of the gradient with respect to b, it was found experimentally that a starting value of b≈5 performed best. More recent work suggests that initializing γ>1 could simplify matters. Gamma (γ) becomes a hyperparameter (tuned and set by the user), allowing b to function properly as a variable—randomly initialized and learned correctly by the system. In previous implementations, b functioned as a hybrid (e.g., as both a hyperparameter and a variable); this arrangement separates that functionality out.

TABLE 1
Hyperparameter values for aaPU

| | | | Learning | |
|---|---|---|---|---|
| Dataset | Architecture | Optimizer | rate | Epoch |
| MNIST | 3-layer CNN | Adam | 1e−5 | 100 |
| Cats-vs -Dogs | EfficientNetBO | Adam | 2e−5 | 125 |
| STL-10 | EfficentNetBO | Adam | 1e−4 + | 100 |
| | | | scheduler | |

### 5. Results

### 5.1 MNIST Dataset

To evaluate performance on the multiclass MNIST dataset, the binary subproblem of comparing the easily confusable digit 3 with the digit 5 was selected. Each class had approximately 6000 examples. Threes were selected to be positive and fives to be negative. Five experiments were run, and their results averaged to minimize variance.

TABLE 2
MNIST results percentage accuracy by algorithm

| c value | NaivePU | nnPU | aPU | aaPU |
|---|---|---|---|---|
| 100 samples | 46.9 | 47.5 | 59.3 | 94.6 |
| c ≈ 0.017 | | | | |
| 0.1 | 48.4 | 93.1 | 96.2 | 98.8 |
| 0.3 | 63.7 | 96.8 | 98.6 | 99.4 |

### 5.2 Cats-Vs-Dogs Dataset

The Cats-vs-Dogs (CVD) dataset has 25,000 images, evenly split between cats and dogs. The images are large (224×224×3) and complex—often having background objects, multiple animals, or the cat or dog in unusual orientations. This dataset is commonly used as a benchmark for supervised image classification, though not typically known to benchmark PU learning. Experiment results on this dataset are shown in Table 3.

While all algorithms other than the NaivePU performed well when only ten percent of the positive class was labeled, only the system 100 (aaPU) performed well when only one percent was labeled (125 labeled images out of 25,000 total).

TABLE 3
CVD dataset percentage accuracy by algorithm

| c value | NaivePU | nnPU | aPU | aaPU |
|---|---|---|---|---|
| 0.01 | 49.9 | 50.6 | 85.1 | 98.7 |
| 0.1 | 49.9 | 96.5 | 97.4 | 98.8 |

### 5.3 STL-10 Dataset

The STL-10 dataset has ten classes: Airplane, Bird, Car, Cat, Deer, Dog, Horse, Monkey, Ship, and Truck. The dataset is designed for open-set semi-supervised learning. 500 labeled training samples are provided for each class and 100,000 unlabeled samples from a different, though similar distribution. The presence of distractor classes in the unlabeled training set provides additional realism.

The classes were split into two to allow for PU classification with binary_class_1 having the Plane, Car, Cat, Ship, and Truck classes and binary_class_2 including the remaining Bird, Deer, Dog, Horse, and Monkey classes. Two experiments were defined: STL-10a has binary_class_1 as the positive class and binary_class_2 as negative and STL-10b is reversed with binary_class_2 being positive. All positive labeled data was labeled positive, and all negative data and all unlabeled images were unknown. This means that each experiment had 2500 labeled images and 100,250 unlabeled images. The exact c value was unknown. Because not all labeled images were used in PU learning, PU results are not comparable to general SSL results on this dataset.

Due to the distractor data in the unlabeled dataset, results were lower in this dataset than in previous tests. However, the system 100 performed better than others in both STL experiments as shown in Table 4.

TABLE 4
STL-10 dataset percentage accuracy by algorithm

| Variant | nnPU | aPU | aaPU |
|---|---|---|---|
| STL-10a | 80.7 | 80.2 | 84 |
| STL-10b | 82.1 | 82.7 | 87.3 |

The system 100 employing an adaptive asymmetric loss function presented in this disclosure effectively learns a binary classifier on positive unlabeled (PU) data. The system 100 outperforms current state-of-the-art algorithms, notably when the proportion of labeled samples is very low and in realistic open training set problems such as STL-10. While the SCAR assumption was explicitly made in the experimental study, preliminary experimentation with biased data has shown very promising results. Similarly, while only image datasets were used in this disclosure, it is anticipated that this system 100 can work well with other types of high dimensional data. Future work can include both scenarios, as well as further tuning of the regularization hyperparameter γ.

### 6. Computing Device

FIG. 3 is a schematic block diagram of an example device 200 that may be used with one or more embodiments described herein, e.g., as a component of system 100.

Device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 220 and network interfaces 210 for storing software programs and data structures associated with the embodiments described herein. In some embodiments, device 200 may have limited memory or no memory (e.g., no memory for storage other than for programs/processes operating on the device and associated caches). Memory 240 can include instructions executable by the processor 220 that, when executed by the processor 220, cause the processor 220 to implement aspects of the system 100 and associated methods outlined herein.

Processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include PU-Based Classification processes/services 290, which can include aspects of the methods and/or implementations of various modules described herein. Note that while PU-Based Classification processes/services 290 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the PU-Based Classification processes/services 290 is shown as a standalone process, those skilled in the art will appreciate that this process may be executed as a routine or module within other processes.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system for positive and unlabeled learning, comprising:
a processor in communication with a memory, the memory including instructions executable by the processor to:
access an input dataset for classification, the input dataset limited to unlabeled data from a positive class and posing a positive and unlabeled (PU) problem; and
train a classifier defined by a modified logistic regression (MLR) algorithm to solve the PU problem using an adaptive asymmetric loss function whose level of asymmetry is dependent upon a learned label frequency of the input dataset, the learned label frequency learned during training such that the level of asymmetry is adaptive; and
calculate a probability that a datapoint associated with the input dataset is labeled using the classifier as trained.

2. The system of claim 1, wherein the classifier is a non-traditional classifier defined by a modified logistic regression (MLR) algorithm.

3. The system of claim 1, wherein the adaptive asymmetric loss function is based on the structure of the input dataset.

4. The system of claim 1, the memory further including instructions executable by the processor to:
determine a probability that each datapoint of the input dataset is positively labeled; and
determine the learned label frequency of the input dataset.

5. The system of claim 1, wherein the classifier incorporates an exponentiated output of a deep neural network.

6. The system of claim 1, wherein the processor pairs a linear transform with an output of the adaptive asymmetric loss function such that the classifier as trained is inductive and does not require an estimate of a prior class.

7. The system of claim 6, wherein the linear transform converts the classifier from a non-traditional classifier to a traditional classifier.
